(19) United States
(12) Patent Application Publication
(10) Pub. No.: US 2017/0094684 A1
(43) Pub. Date: Mar. 30, 2017

(54) CLEAR CHANNEL ASSESSMENT PROCEDURES IN SYNCHRONIZED NETWORKS

(71) Applicant: QUALCOMM Incorporated, San Diego, CA (US)

(72) Inventors: Chong Li, Jersey City, NJ (US); Lei Zhang, New Brunswick, NJ (US); Xinzhou Wu, Hillsborough, NJ (US); Junyi Li, Chester, NJ (US); Rakesh Dugad, Basking Ridge, NJ (US)

(21) Appl. No.: 14/864,608

(22) Filed: Sep. 24, 2015

(51) Int. Cl. H04W 74/08; H04W 24/08; H04L 27/00

(52) U.S. Cl. CPC H04W 74/0808; H04L 27/0006; H04W 24/08; H04W 84/12

(57) ABSTRACT

Methods, systems, and devices for wireless communication are described. A first device in a synchronous network performs a first clear channel assessment (CCA) procedure on a channel; identifies the channel as being available based at least in part on the first CCA procedure; and transmits a packet on the channel immediately following the completion of the first CCA procedure. A second device performs a CCA procedure on the channel using the same count-down duration if the first and second devices are associated with the same first operator. If the first and second devices are associated with different operators, the second device performs a second CCA procedure on the channel having a different count-down duration than the count-down duration of the first CCA procedure.

### BACKGROUND

The following relates generally to wireless communication, and more specifically to clear channel assessment (CCA) procedures in synchronized networks.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

One of the current issues in wireless technology is the efficiency of packet transmission, including when to send a packet. Currently, a wireless device queries the channel before sending communications to determine whether the channel is clear. If the device attempts packet transmission at the same time as another device, a collision may occur which may be detrimental to both system performance and user experience.

Typically, CCA involves two functions: carrier sensing (CS) and energy detection (ED). In a Wireless Fidelity (Wi-Fi) system, CCA is performed before every data packet transmission. In an unlicensed radio frequency spectrum band, where the system is a synchronized slotted system, CCA invoking only energy detection may be performed in a special subframe. The special subframe may be the uplink-downlink transition subframe. If CCA clears ahead of the subframe boundary, the transmitter remains idle.

### SUMMARY

Techniques are described to avoid communication or packet collisions that reduce packet transmission efficiency and system performance in a wireless communication network. Collisions may occur when two devices simultaneously transmit a packet on a channel. A clear channel assessment (CCA) may be utilized to minimize collisions. CCAs may involve two methods of identifying existing packet transmission: carrier sensing and energy detection.

In some wireless local area networks (WLANs), devices may perform CCA before every data packet transmission. A CCA may be based on energy detection in an uplink-downlink (UL/DL) transition subframe and/or a DL/UL subframe. The CCA procedure may include both carrier sensing and energy detection. More specifically, a base station may detect whether the channel is busy by measuring the energy in the channel during the time slot (i.e., energy detection), and by attempting to decode a physical layer convergence protocol (PLCP) header from neighboring WLAN transmissions (i.e., carrier sensing). The base station's CCA procedure may start in the UL/DL transition subframe and continue until the CCA procedure is complete. Packet transmission may start as soon as the CCA completes. When a CCA completes, the data transmission may start and continue until the UL/DL or DL/UL boundary.

A method of wireless communication is described. The method may include performing, by a first device in a synchronous network, a first clear channel assessment (CCA) procedure on a channel, identifying the channel as being available based at least in part on the first CCA procedure and transmitting a packet on the channel immediately following a completion of the first CCA procedure.

An apparatus for wireless communication is described. The apparatus may include means for performing, by a first device in a synchronous network, a first CCA procedure on a channel, means for identifying the channel as being available based at least in part on the first CCA procedure and means for transmitting a packet on the channel immediately following a completion of the first CCA procedure.

A further apparatus is described. The apparatus may include a processor, memory in electronic communication with the processor, and instructions stored in the memory. The instructions may be operable to cause the processor to perform, by a first device in a synchronous network, a first CCA procedure on a channel, identify the channel as being available based at least in part on the first CCA procedure and transmit a packet on the channel immediately following a completion of the first CCA procedure.

A non-transitory computer readable medium for wireless communication is described. The non-transitory computer-readable medium may include instructions to cause a processor to perform, by a first device in a synchronous network, a first CCA procedure on a channel, identify the channel as being available based on the first CCA procedure and transmit a packet on the channel immediately following a completion of the first CCA procedure.

In some examples of the method, apparatus, or non-transitory computer-readable medium described above, performing the first CCA procedure further comprises: starting the first CCA procedure simultaneously with a second CCA procedure performed by a second device, the first CCA procedure and the second CCA procedure having a same count-down duration.

In some examples of the method, apparatus, or non-transitory computer-readable medium described above, the first device and the second device are associated with a first operator of the synchronous network.

In some examples of the method, apparatus, or non-transitory computer-readable medium described above, performing the first CCA procedure further comprises: starting the first CCA procedure simultaneously with a second CCA procedure performed by a second device, the first CCA procedure having a first count-down duration and the second CCA procedure having a second count-down duration that is different from the first count-down duration.

In some examples of the method, apparatus, or non-transitory computer-readable medium described above, the first device is associated with a first operator of the synchronous network and the second device is associated with a second operator of the synchronous network, the second operator being different from the first operator.

In some examples of the method, apparatus, or non-transitory computer-readable medium described above, performing the first CCA procedure further comprises: identifying a special subframe between a first subframe and a second subframe, where the special subframe is identified prior to the first subframe. Some examples of the method, apparatus, or non-transitory computer-readable medium described above may further include processes, features, means, or instructions for performing the first CCA procedure during at least a portion of the special subframe.

In some examples of the method, apparatus, or non-transitory computer-readable medium described above, transmitting the packet on the channel immediately following the completion of the first CCA procedure further comprises: identifying that the completion of the first CCA procedure occurs prior to a boundary of the special subframe. Some examples of the method, apparatus, or non-transitory computer-readable medium described above may further include processes, features, means, or instructions for transmitting a dummy packet or a data packet until the boundary of the special subframe.

In some examples of the method, apparatus, or non-transitory computer-readable medium described above, transmitting the packet on the channel immediately following the completion of the first CCA procedure further comprises: identifying that the completion of the first CCA procedure occurs at a boundary of the special subframe. Some examples of the method, apparatus, or non-transitory computer-readable medium described above may further include processes, features, means, or instructions for transmitting a data packet during each subframe following the special subframe.

In some examples of the method, apparatus, or non-transitory computer-readable medium described above, transmitting the packet on the channel immediately following the completion of the first CCA procedure further comprises: identifying that the completion of the first CCA procedure occurs after a boundary of the special subframe. Some examples of the method, apparatus, or non-transitory computer-readable medium described above may further include processes, features, means, or instructions for transmitting a dummy packet or a data packet until the boundary of a subsequent subframe.

In some examples of the method, apparatus, or non-transitory computer-readable medium described above, the first subframe comprises an uplink (UL) subframe and the second subframe comprises a downlink (DL) subframe or the first subframe comprises a DL subframe and the second subframe comprises an UL subframe.

Some examples of the method, apparatus, or non-transitory computer-readable medium described above may further include processes, features, means, or instructions for identifying data to be transmitted on the channel. Some examples of the method, apparatus, or non-transitory computer-readable medium described above may further include processes, features, means, or instructions for performing the first CCA procedure based on the identifying.

In some examples of the method, apparatus, or non-transitory computer-readable medium described above, performing the first CCA procedure further comprises: measuring energy on the channel. Some examples of the method, apparatus, or non-transitory computer-readable medium described above may further include processes, features, means, or instructions for decoding one or more physical (PHY) layer convergence procedure (PLCP) headers associated with one or more wireless fidelity (Wi-Fi) transmissions during the special sub frame.

Some examples of the method, apparatus, or non-transitory computer-readable medium described above may further include processes, features, means, or instructions for transmitting the packet on the channel during each subsequent subframe until a special subframe occurs. Some examples of the method, apparatus, or non-transitory computer-readable medium described above may further include processes, features, means, or instructions for performing a second CCA procedure during the special subframe.

In some examples of the method, apparatus, or non-transitory computer-readable medium described above, the first device comprises a base station or a UE.

### BRIEF DESCRIPTION OF THE DRAWINGS

FIG. 1 illustrates an example of a wireless communications system that supports clear channel assessment (CCA) procedures in synchronized networks in accordance with aspects of the present disclosure;

FIG. 2 illustrates an example of a wireless communications system that supports CCA procedures in synchronized networks in accordance with aspects of the present disclosure;

FIG. 3 illustrates an example of a frame diagram that supports CCA procedures in synchronized networks in accordance with aspects of the present disclosure;

FIG. 4 illustrates an example of a process flow in a system that supports CCA procedures in synchronized networks in accordance with aspects of the present disclosure;

FIGS. 5-8 illustrates a block diagram of an example device that supports CCA procedures in a synchronized networks in accordance with aspects of the present disclosure; and

FIGS. 9-13 illustrate methods for CCA procedures in synchronized networks in accordance with aspects of the present disclosure.

### DETAILED DESCRIPTION

A wireless network may employ techniques to avoid communication or packet collisions that reduce packet transmission efficiency and system performance. Collisions may occur when two devices simultaneously transmit a packet on a channel. A clear channel assessment (CCA) may be utilized to minimize collisions. CCAs may involve two methods of identifying existing packet transmission: carrier sensing and energy detection.

In some wireless local area networks (WLANs), devices may perform CCA before every data packet transmission. Other systems, such as a wireless wide area network (WWAN) operating in contention based spectrum, may transmit several packets following each successful CCA. For example, in a WWAN system based on time division duplexing (TDD), a CCA may be performed for a number of consecutive frames identified for downlink (DL) transmissions.

In one example, a CCA may be based on energy detection in an uplink-downlink (UL/DL) transition subframe and/or a DL/UL subframe. For each base station belonging to a single operator, the CCA procedure may begin at the same point in time. For example, base stations belonging to a first operator may begin the CCA procedure at time x within the subframe; whereas base stations belonging to a second operator may begin the CCA procedure at time y within the subframe.

Regardless of the CCA starting point, if the CCA clears ahead of a subframe boundary, such as the downlink channel usage beacon signal (D-CUBS) boundary, the base station may experience an idle period. In one embodiment, a data packet or a content free “junk” packet may be transmitted during the remaining portion of the subframe following the completion of the CCA, but prior to the D-CUBS boundary. The transmission of a “junk” packet may be used as a channel reservation to reduce the chance for another UE to break into the frame and potentially cause a collision. Once the CCA completes, the data transmission may continue until the next uplink-downlink or downlink-uplink transition Occurs.

The CCA procedure may include both carrier sensing and energy detection. More specifically, the base station may detect whether the channel is busy by measuring the energy in the channel during the time slot (i.e., energy detection), and by attempting to decode a physical layer convergence protocol (PLCP) header from neighboring WLAN transmissions (i.e., carrier sensing). The base station's CCA procedure may start in the UL/DL transition subframe and continue until the CCA procedure is complete. Packet transmission may start as soon as the CCA completes. When a CCA completes, the data transmission may start and continue until the UL/DL or DL/UL boundary (e.g., D-CUBS boundary).

Aspects of the disclosure are initially described in the context of an example wireless communication system, and are further illustrated by and described with reference to apparatus diagrams, system diagrams, and flowcharts that relate to CCA procedures in synchronized networks.

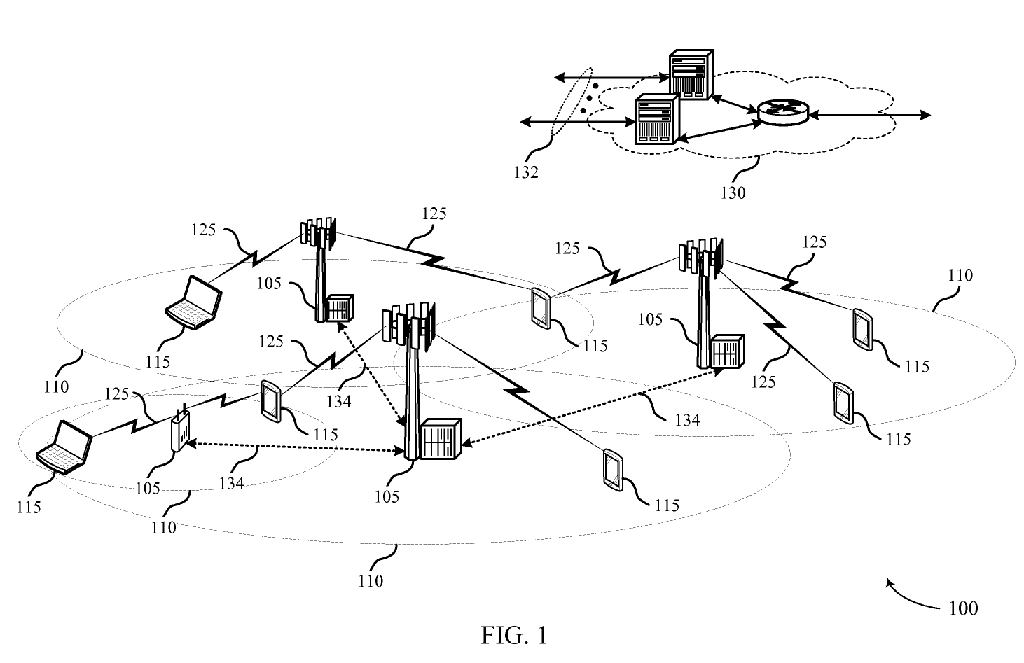

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Base stations 105 may wirelessly communicate with UEs 115 via one or more base station antennas. Each base station 105 may provide communication coverage for a respective geographic coverage area 110. Communication links 125 shown in wireless communications system 100 may include UL transmissions from a UE 115 to a base station 105, or DL transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device or the like.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller. In some examples, base stations 105 may be macro cells, small cells, hot spots, etc. Base stations 105 may also be referred to as evolved NodeBs (eNBs) 105.

In some cases, a UE 115 or base station 105 may operate in a shared or unlicensed frequency spectrum. These devices may perform a CCA prior to communicating in order to determine whether the channel is available. A CCA may include an energy detection procedure to determine whether there are any other active transmissions. For example, the device may infer that a change in a signal strength of a power meter indicates that a channel is occupied. Specifically, signal power is that is concentrated in a certain bandwidth and exceeds a predetermined noise floor may indicate another wireless transmitter transmitting in the channel. A CCA may also include detection of specific sequences that indicate use of the channel. For example, another device may transmit a specific preamble prior to transmitting a data sequence.

In some cases, a wireless communications system may utilize one or more enhanced component carrier (ECCs). An ECC may be characterized by one or more features including: flexible bandwidth, variable length transmission time intervals (TTIs), and modified control channel configuration. In some cases, an ECC may be associated with a carrier aggregation configuration or a dual connectivity configuration (i.e., when multiple serving cells have a suboptimal backhaul link). An ECC may also be configured for use in unlicensed spectrum or shared spectrum (where more than one operator is licensed to use the spectrum). An ECC characterized by flexible bandwidth may include one or more segments that may be utilized by UEs 115 that do are not capable of monitoring the whole bandwidth or prefer to use a limited bandwidth (e.g., to conserve power).

In some cases, an ECC may utilize a variable TTI length, which may include use of a reduced or variable symbol duration. In some cases the symbol duration may remain the same, but each symbol may represent a distinct TTI. In some cases an ECC may include multiple hierarchical layers associated with the different TTI lengths. For example, TTIs at one hierarchical layer may correspond to uniform 1 millisecond (ms) subframes, whereas in a second layer, variable length TTIs may correspond to bursts of short duration symbol periods. In some cases, a shorter symbol duration may also be associated with increased subcarrier spacing.

Flexible bandwidth and variable TTIs may be associated with a modified control channel configuration (e.g., an ECC may utilize an enhanced physical downlink control channel (ePDCCH) for DL control information). For example, one or more control channels of an ECC may utilize frequency-division multiplexing (FDM) scheduling to accommodate flexible bandwidth use. Other control channel modifications include the use of additional control channels (e.g., for evolved multimedia broadcast multicast services (eMBMS) scheduling, or to indicate the length of variable length UL and DL bursts), or control channels transmitted at different intervals. An ECC may also include modified or additional hybrid automatic repeat request (HARQ) related control information.

In one embodiment, a device (e.g., a UE 115 and/or a base station 105, etc.) in a synchronous wireless network may begin a CCA in a special subframe. The device may detect whether the channel is busy by measuring the energy in the channel during the time slot (i.e., energy detection), and by attempting to decode a physical layer convergence protocol (PLCP) header from neighboring WLAN transmissions. If the CCA completes before the DL/UL or UL/DL boundary, then the device transmits a data packet immediately upon CCA completion.

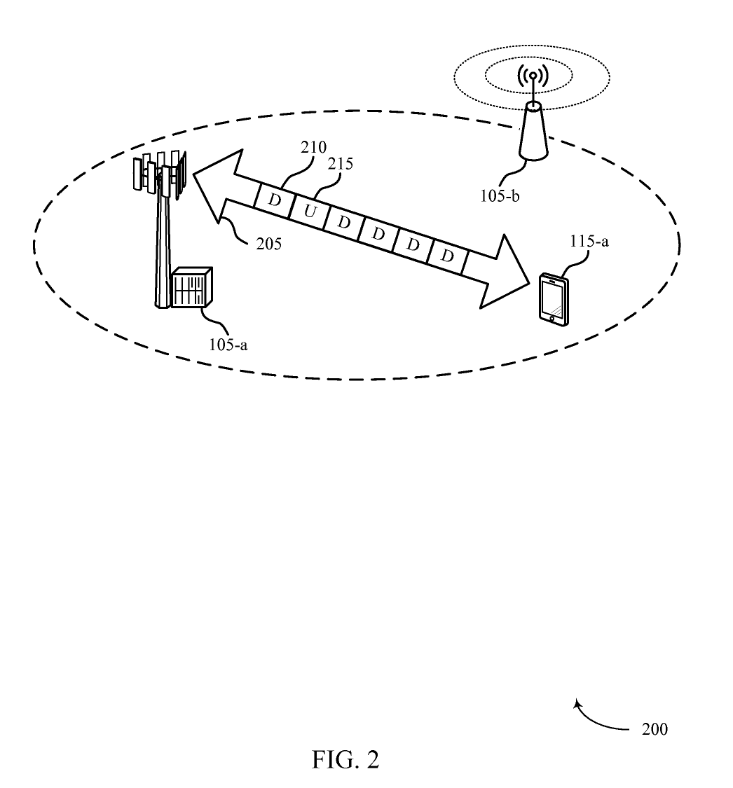

FIG. 2 illustrates an example of a wireless communications system 200 for CCA procedures in synchronized networks. Wireless communications system 200 may include a UE 115-a, a base station 105-a, and in some embodiments, a small radio access node (e.g., small cell, macrocell, pico cell, etc.) 105-b, which may be examples of the corresponding devices described with reference to FIG. 1. In one embodiment, FIG. 2 describes a medium access channel (MAC) layer channel access mechanism for a LTE continuous wave (LTE-CW) system.

Wireless communications system 200 may employ techniques for reducing the odds of packet collisions that may reduce packet transmission efficiency and system performance. Packet collisions may occur when two devices (e.g., base station 105-a and a small cell base station 105-b) simultaneously transmit a packet on a channel. In order to reduce the probability of collisions, a CCA procedure may be performed. The CCA procedure may involve two methods of identifying existing packet transmission: carrier sensing and energy detection.

Carrier sensing may be related to the ability of a device to detect and decode a WiFi preamble. More specifically, the time duration of which the channel may be occupied may be determined from the PLCP header field of the WiFi preamble. Energy detection may be related to the ability of a device to detect non-WiFi energy in the channel, which may include transmissions from small cell base station 105-b.

In some WLANs, a device may perform a CCA before every data packet transmission. In other systems, such as a WWAN operating in a contention based spectrum, base station 105-a may transmit several packets following each successful CCA. Packets may be contained in DL subframes 210 or may be contained in UL subframes 215. For example, in a WWAN system based on TDD, a CCA may be performed for a number of consecutive DL subframes 210 identified for downlink transmissions.

In one embodiment, base station 105-a CCA may include both carrier sensing and energy detection. Base station 105-a and/or UE 115-a may begin a CCA in a UL-DL transition subframe (or a DL-UL transition subframe) and continue until it the CCA is complete. A header or data packet may be transmitted immediately after the completion of the CCA in the subframe. In some embodiment, if the CCA finishes before the UL-DL boundary, a content-free “junk” packet may be transmitted during the remaining portion of the subframe following the completion of the CCA, but prior to the D-CUBS boundary. The transmission of the “junk” packet may be used to reserve the channel so that another device has a reduced chance to break into the channel. Once the CCA succeeds, the data transmission 205 may continue until the next UL-DL or DL-UL subframe transition boundary Occurs.

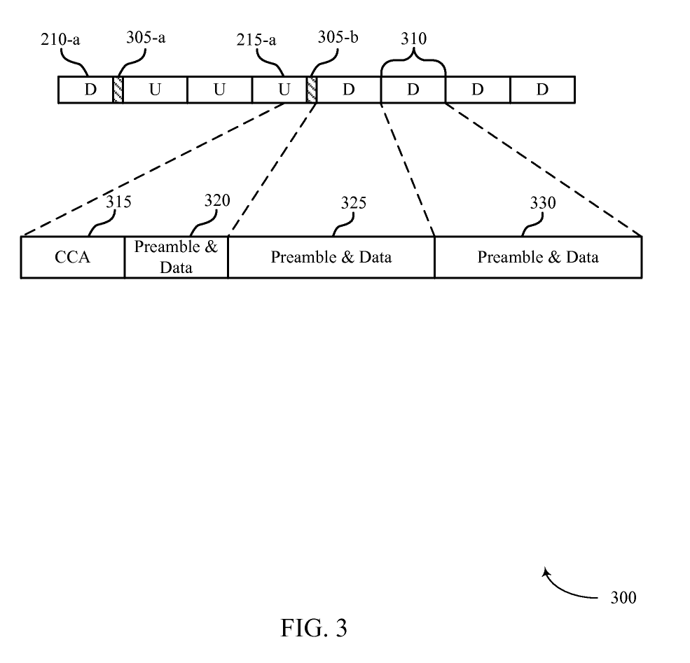

FIG. 3 illustrates an example of a frame diagram 300 for CCA procedures in synchronized networks. In some cases, frame diagram 300 may represent aspects of techniques performed by a device such as UE 115 or base station 105 as described with reference to FIGS. 1-2. In one embodiment, base station 105 and/or UE 115 may begin a CCA procedure and data transmission as shown in the portion of frame diagram 300 of FIG. 3.

Frame diagram 300 may contain a number of subframes 310. Although FIG. 3 indicates subframe 310 to be a DL subframe, subframe 310 may be an UP subframe 215 or a DL subframe 210. In some cases, the subframe 310 may be a DL/UP transition subframe 210-a or an UP/DL transition subframe 215-a. At a special subframe before the DL/UL transition boundary and/or example UP/DL transition boundary, CCA 315 may be performed. The CCA procedure may begin at any time within the subframe boundary, however, every device associated with an operator will being the device's CCA procedure at the same time within the subframe boundary. Devices associated with a different, second, operator will begin the CCA procedure at a different time from devices associated with a different operator, but all devices associated with the same operator will being the CCA procedure at the same time.

Once the CCA procedure beings, the procedure begins a count-down until completion, with completion hopefully ending at the subframe boundary. However, the CCA 315 may successfully complete before the UL/DL boundary (e.g. a D-CUBS boundary), thus partial subframe 305-b (or partial subframe 305-a at the end of subframe 210-a) may remain before the boundary. In some embodiments, the remaining partial subframe 305-b may cause the base station to sit idle and other devices to transmit packets on the channel, increasing the possibility of a collision before the subframe boundary.

Thus, partial subframe 305-b may be used to transmit a “junk” data packet. The transmission of a “junk” packet may be used as a channel reservation to reduce the chance for another device to break into the frame and potentially cause a collision. At the subframe boundary, a preamble and data transmission begins and continues through DL frame 325 and DL frame 330 until completion. In some embodiments, the CCA procedure may not complete until the subframe boundary has passed, thus extending the CCA procedure into the next subframe. In the embodiment where the CCA procedure has passed the subframe boundary, the CCA procedure will continue until completion. If CCA completes before the next subframe boundary, then a junk packet may be sent to reserve the channel until data transmission begins.

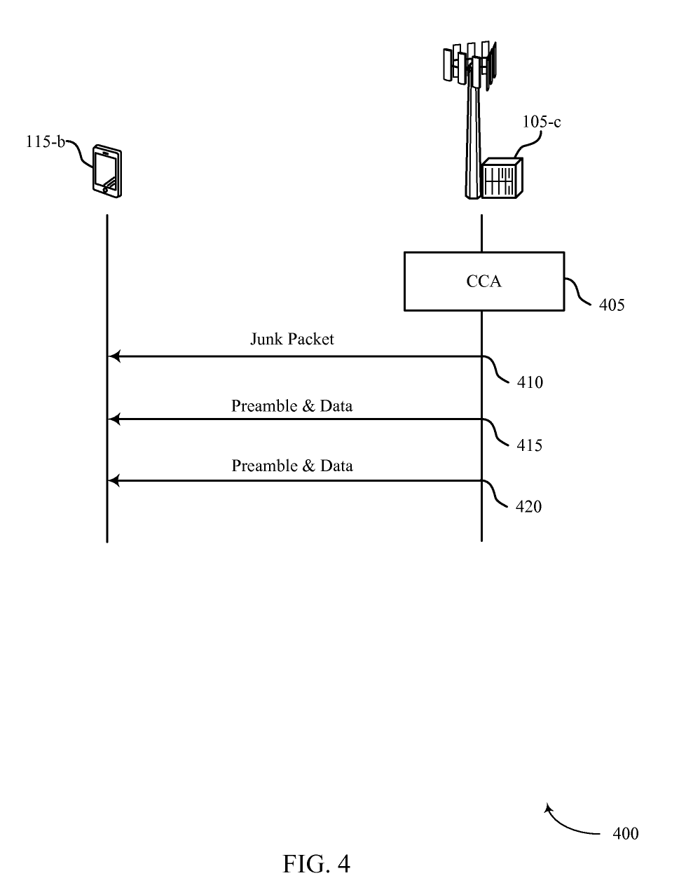

FIG. 4 illustrates an example of a process flow 400 for clear channel assessment procedures in synchronized networks in accordance with various aspects of the present disclosure. Process flow 400 may include an example base station 105-a and UE 115-a, which may be examples of the corresponding devices described with reference to FIGS. 1-2.

At step 405, base station 105-c may initiate a CCA procedure using both carrier sensing and energy detection. The CCA procedure may be performed before a DL transmission and/or an UL transmission. For each base station associated with the same operator as base station 105-c, the CCA procedure will begin with a synchronous start time. For base stations associated with a different operator (i.e., not the operator associated with base station 105-c), the CCA procedure start time will be different.

At step 410, the CCA completes before the subframe boundary and base station 105-c may transmit a junk packet to UE 115-b. At step 415, base station 105-c may begin transmission of a preamble and data packet to UE 115-b, with the transmission continuing through step 420 (and within a subsequent subframe as shown with respect to FIG. 3).

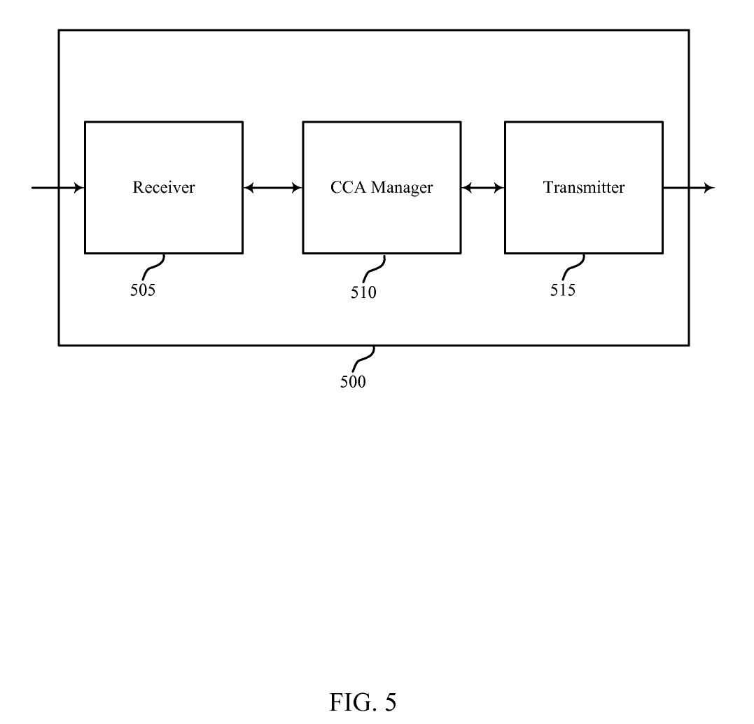

FIG. 5 shows a block diagram of a wireless device 500 that supports clear channel assessment procedures in synchronized networks in accordance with various aspects of the present disclosure. Wireless device 500 may be an example of aspects of a UE 115 or base station 105 described with reference to FIGS. 1 and 2. Wireless device 500 may include receiver 505, CCA manager 510 and transmitter 515. Wireless device 500 may also include a processor. Each of these components may be in communication with each other.

The receiver 505 may receive information such as packets, user data, or control information associated with various information channels (e.g., control channels, data channels, and information related to clear channel assessment procedures in synchronized networks, etc.). Information may be passed on to other components of the device.

The CCA manager 510 may be associated with a device initiating a CCA procedure. The CCA manager may thus use carrier sensing and energy detection to determine whether a channel is occupied or available. When the CCA procedure has completed, the CCA manager may indicated to the transmitter 515 to begin transmission of a data packet on the channel.

The transmitter 515 may transmit signals received from other components of wireless device 500. The transmitter may transmit data packets at the completion of the CCA procedure. In some examples, the transmitter 515 may be collocated with a receiver in a transceiver module. The transmitter 515 may include a single antenna, or it may include a plurality of antennas.

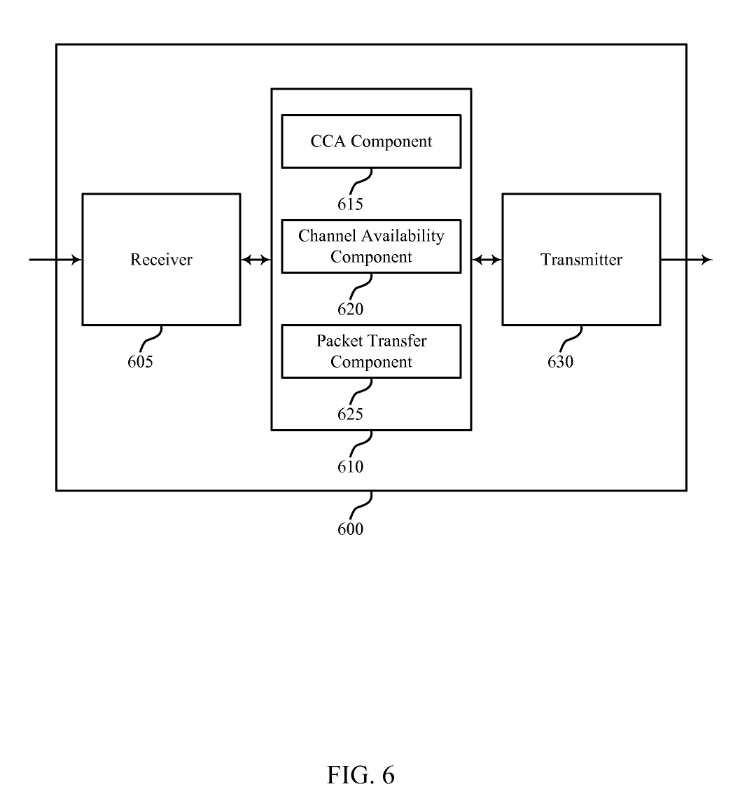

FIG. 6 shows a block diagram of a wireless device 600 that supports CCA procedures in synchronized networks in accordance with various aspects of the present disclosure. Wireless device 600 may be an example of aspects of a wireless device 500 and/or a UE 115 and/or a base station 105 described with reference to FIGS. 1, 2 and 5. Wireless device 600 may include receiver 605, CCA manager 610 and transmitter 630. Wireless device 600 may also include a processor. Each of these components may be in communication with each other.

The receiver 605 may receive information which may be passed on to other components of the device. The receiver 605 may also perform the functions described with reference to the receiver 505 of FIG. 5.

The CCA manager 610 may be an example of aspects of CCA manager 510 described with reference to FIG. 5. The CCA manager 610 may include CCA component 615, channel availability component 620 and packet transfer component 625.

The CCA component 615 may perform a first CCA procedure on a channel during at least a portion of a special subframe. In one embodiment, the CCA component 615 may begin the first CCA procedure simultaneously with a second CCA procedure performed by a second device. The CCA component 615 may further enable the first CCA procedure and the second CCA procedure to begin simultaneously and possess the same count-down duration. In the embodiment where the first and second CCA procedures have the same count-down duration, the first and second devices may be associated with the same operator. In another embodiment CCA component 615 may further enable the first CCA procedure for a first device having a count-down duration which differs from a second CCA procedure for a second device. In this example embodiment, the first and second devices may be associated with different operators.

The channel availability component 620 may identify the channel as being available based at least in part on a CCA procedure at least in part through carrier sensing and energy detection.

The packet transfer component 625 may transmit a junk packet and/or a data packet on the channel immediately following a completion of the first CCA procedure. In some embodiments, the packet may be transmitted until the boundary of the special subframe, the junk and/or data packet may be transmitted during each subframe following the special subframe, the junk and/or data packet may be transmitted until the boundary of a subsequent subframe, the junk and/or data packet may be transmitted on the channel during each subsequent subframe until a special subframe occurs, and/or the junk packet and/or data packet may be transmitted on the channel immediately following a completion of the first CCA procedure.

The transmitter 630 may transmit signals received from other components of wireless device 600. In some examples, the transmitter 630 may be collocated with a receiver in a transceiver module. The transmitter 630 may utilize a single antenna, or it may utilize a plurality of antennas.

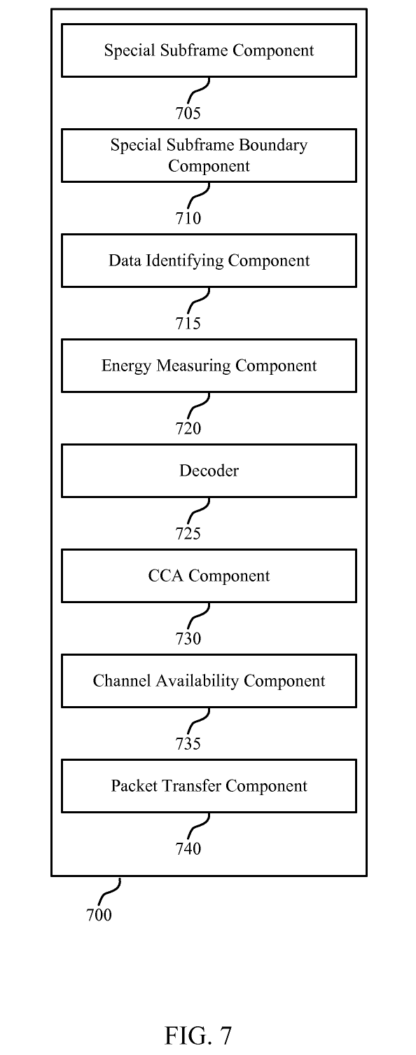

FIG. 7 shows a block diagram of a CCA manager 700 which may be an example of the corresponding component of wireless device 500. For example, CCA manager 700 may be an example of aspects of CCA manager 510 described with reference to FIG. 5. The CCA manager 700 may include special subframe component 705, special subframe boundary component 710, data identifying component 715, energy measuring component 720, decoder 725, CCA component 730, channel availability component 735, packet transfer component 740 and special subframe component 745. Each of these modules may communicate, directly or indirectly, with one another (e.g., via one or more buses).

The special subframe component 705 may perform the first CCA procedure at least in part by identifying, before the occurrence of the first subframe, a special subframe between a first subframe and a second subframe. In some embodiments, the first subframe is an UL subframe and the second subframe is a DL subframe. In other embodiments, the first subframe is a DL subframe and the second subframe is a UL subframe.

When the packet is transmitted on the channel immediately following the completion of the first CCA, the special subframe boundary component 710 may identify that the completion of the first CCA procedure occurs prior to a boundary of the special subframe. In another embodiment the special subframe boundary component identifies that the completion of the first CCA procedure occurs at a boundary of the special subframe. In another embodiment, the special subframe boundary component 710 identifies that the completion of the first CCA procedure occurs after a boundary of the special subframe.

The data identifying component 715 may identify data to be transmitted on the channel, such as whether a data packet or a junk packet will be transmitted. The energy measuring component 720 may detect whether the channel is busy by measuring the energy in the channel during the time slot. The decoder 725 may decode one or more physical layer convergence procedure (PLCP) headers associated with one or more Wi-Fi transmissions during the special subframe.

The CCA component 730 may enable a first device to perform a first CCA procedure on a channel during at least a portion of a special subframe. In one embodiment, the CCA component may perform the first CCA procedure based at least in part on the identifying that the special subframe resides between a first and a second subframe. In one embodiment, the CCA component 730 may begin the first CCA procedure simultaneously with a second CCA procedure performed by a second device. The CCA component 730 may further enable the first CCA procedure and the second CCA procedure to begin simultaneously and possess the same count-down duration. In the embodiment where the first and second CCA procedures have the same count-down duration, the first and second devices may be associated with the same operator. In another embodiment CCA component 730 may further enable the first CCA procedure for a first device having a count-down duration which differs from a second CCA procedure for a second device. In this example embodiment, the first and second devices may be associated with different operators.

The channel availability component 735 may identify the channel as being available based at least in part on a CCA procedure at least in part through carrier sensing and energy detection, and may be synonymous with the channel availability component 635 described with referenced to FIG. 6

The packet transfer component 740 may transmit a junk packet and/or a data packet on the channel immediately following a completion of the first CCA procedure. In some embodiments, the packet may be transmitted until the boundary of the special subframe, the junk and/or data packet may be transmitted during each subframe following the special subframe, the junk and/or data packet may be transmitted until the boundary of a subsequent subframe, the junk and/or data packet may be transmitted on the channel during each subsequent subframe until a special subframe occurs, and/or the junk packet and/or data packet may be transmitted on the channel immediately following a completion of the first CCA procedure. Packet transfer component 740 may be synonymous with packet transfer component 625 described with reference to FIG. 6.

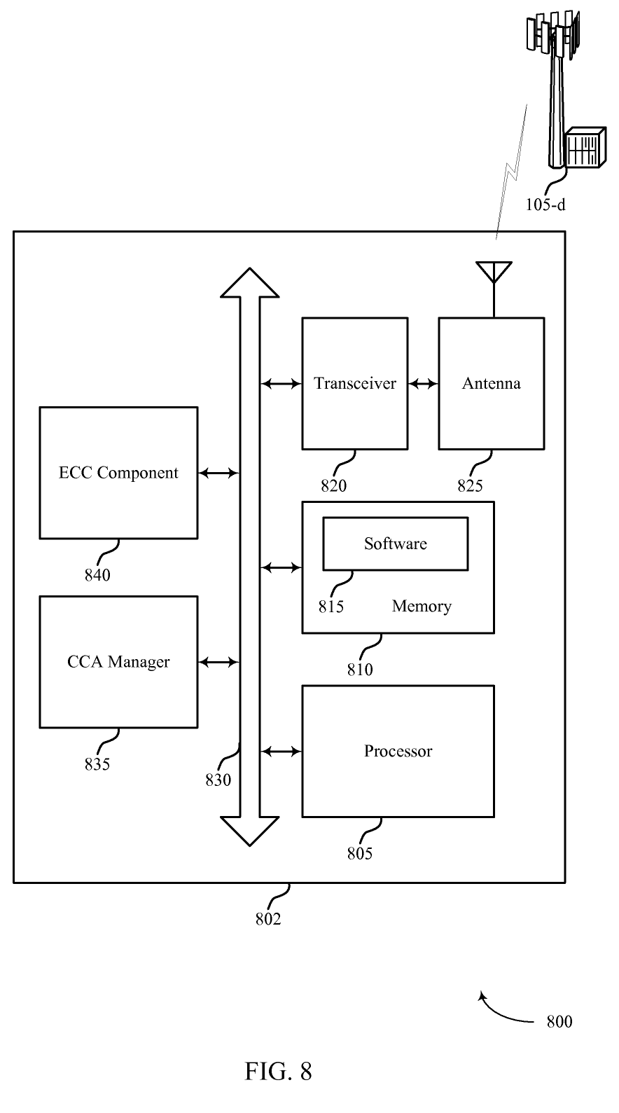

FIG. 8 shows a diagram of a wireless system 800 including a device configured that supports CCA procedures in synchronized networks in accordance with various aspects of the present disclosure. For example, wireless system 800 may include device 802 which may be an example of a wireless device 500 and/or a base station 105 as described with reference to FIGS. 1, 2, and 5. Device 802 may include components for bi-directional voice and data communications including components for transmitting communications and components for receiving communications. For example, device 802 may communicate bi-directionally with one or more UEs 115 and/or base stations 105.

Device 802 may include processor 805, memory 810, transceiver 820, base station communications component 835, CCA manager 840, and network communications component 845. Each of these modules may communicate, directly or indirectly, with one another (e.g., via one or more buses 830). The CCA manager 840 may be an example of a CCA manager 510 as described with reference to FIG. 5.

The processor 805 may include an intelligent hardware device, (e.g., a CPU, a microcontroller, an ASIC, etc.). The memory 810 may include RAM and ROM. The memory 810 may store computer-readable, computer-executable software 815 including instructions that, when executed, cause the processor to perform various functions described herein (e.g., CCA procedures in synchronized networks, etc.). In some cases, the software 815 may not be directly executable by the processor but may cause a computer (e.g., when compiled and executed) to perform functions described herein.

The transceiver 820 may communicate bi-directionally, via one or more antennas 825, wired or wireless links, with one or more networks, as described above. For example, the transceiver 820 may communicate bi-directionally with a base station 105 or a UE 115. The transceiver 820 may also include a modem to modulate the packets and provide the modulated packets to the antennas for transmission, and to demodulate packets received from the antennas. In some cases, the wireless device may include a single antenna 825. However, in some cases the device may have more than one antenna 825, which may be capable of concurrently transmitting or receiving multiple wireless transmissions.

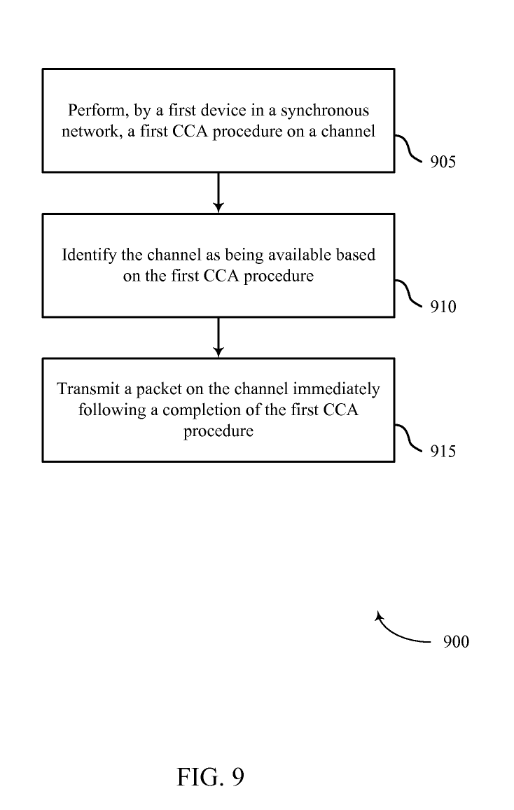

FIG. 9 shows a flowchart illustrating a method 900 for CCA procedures in synchronized networks in accordance with various aspects of the present disclosure. In one embodiment, operations of method 900 may be implemented by a device such as UE 115 and/or base station 105 or its components as described with reference to FIGS. 1 and 2. For example, the operations of method 900 may be performed by the CCA manager 510 as described herein. In some examples, the UE 115 and/or base station 105 may execute a set of codes to control the functional elements of the device to perform the functions described below. Additionally or alternatively, the UE 115 and/or base station 105 may perform aspects the functions described below using special-purpose hardware.

At block 905, a first device in a synchronous network may perform a first CCA procedure on a channel as described above with reference to FIGS. 2 through 8. In certain examples, the operations of block 905 may be performed by the CCA component 615 as described with reference to FIG. 6.

At block 910, the first device may identify the channel as being available based on the first CCA procedure as described above with reference to FIGS. 2 through 8. In certain examples, the operations of block 910 may be performed by the channel availability component 620 as described with reference to FIG. 6.

At block 915, the first device may transmit a packet on the channel immediately following a completion of the first CCA procedure as described above with reference to FIGS. 2 through 8. In certain examples, the operations of block 915 may be performed by the packet transfer component 625 as described with reference to FIG. 6.

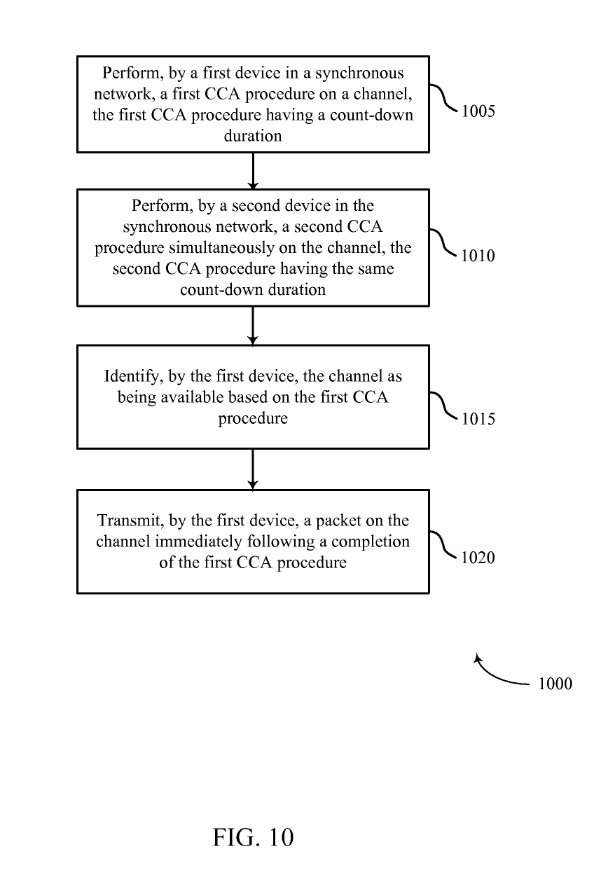

FIG. 10 shows a flowchart illustrating a method 1000 for CCA procedures in synchronized networks in accordance with various aspects of the present disclosure. In one embodiment, the operations of method 1000 may be implemented by a device such as UE 115 and/or base station 105 or its components as described with reference to FIGS. 1 and 2. For example, the operations of method 1000 may be performed by the CCA manager 510 as described herein. In some examples, the UE 115 and/or base station 105 may execute a set of codes to control the functional elements of the device to perform the functions described below. Additionally or alternatively, the UE 115 and/or base station 105 may perform aspects the functions described below using special-purpose hardware.

At block 1005, a first device in a synchronous network may perform a first CCA procedure on a channel, the first CCA procedure having a count-down duration as described above with reference to FIGS. 2-9. In certain examples, the operations of block 1005 may be performed by the CCA manager 510 as described with reference to FIG. 5.

At block 1010, a second device in the synchronous network may perform a second CCA procedure simultaneously on the channel, the second CCA procedure having the same count-down duration as the first device in block 1005 and as described above with reference to FIGS. 2-9. In certain examples, the operations of block 1010 may be performed by the CCA manager as described with reference to FIG. 5.

At block 1015, the first device may identify the channel as being available based on the first CCA procedure as described above with reference to FIGS. 2-9. In certain examples, the operations of block 1015 may be performed by the channel availability component 620 as described with reference to FIG. 6.

At block 1020, the first device may transmit, by the first device, a packet on the channel immediately following a completion of the first CCA procedure as described above with reference to FIGS. 2-9. In certain examples, the operations of block 1020 may be performed by the packet transfer component 625 as described with reference to FIG. 6.

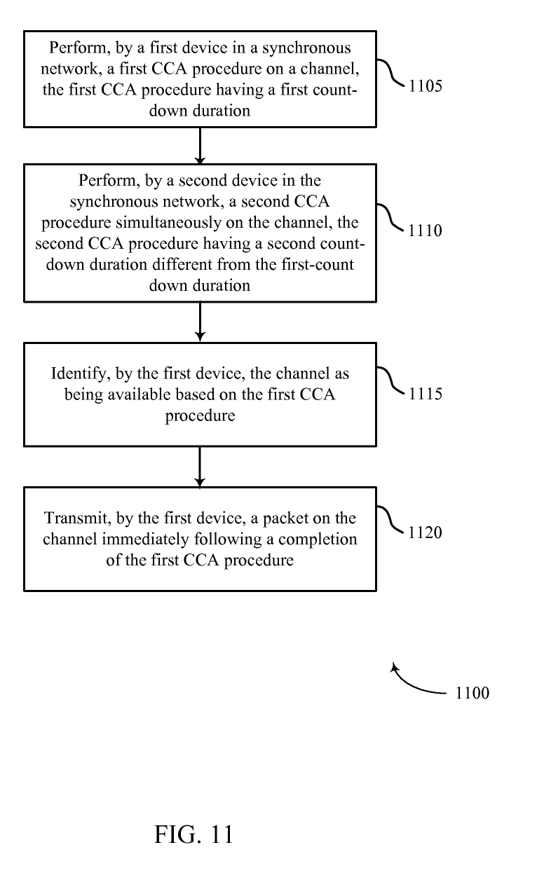

FIG. 11 shows a flowchart illustrating a method 1100 for CCA procedures in synchronized networks in accordance with various aspects of the present disclosure. In one embodiment, the operations of method 1100 may be implemented by a device such as UE 115 and/or base station 105 or its components as described with reference to FIGS. 1 and 2. For example, the operations of method 1100 may be performed by the CCA manager 510 as described herein. In some examples, the UE 115 and/or base station 105 may execute a set of codes to control the functional elements of the device to perform the functions described below. Additionally or alternatively, the UE 115 and/or base station 105 may perform aspects the functions described below using special-purpose hardware.

At block 1105, a first device in a synchronous network may perform a first CCA procedure on a channel, the first CCA procedure having a first count-down duration as described above with reference to FIGS. 2-9. In certain examples, the operations of block 1105 may be performed by the CCA manager 510 as described with reference to FIG. 5.

At block 1110, a second device in the synchronous network may perform a second CCA procedure simultaneously on the channel, the second CCA procedure having a second count-down duration different from the first count-down duration in block 1105 and as described above with reference to FIGS. 2-9. In certain examples, the operations of block 1110 may be performed by the CCA manager 510 as described with reference to FIG. 5.

At block 1115, the first device may identify the channel as being available based on the first CCA procedure as described above with reference to FIGS. 2-9. In certain examples, the operations of block 1115 may be performed by the channel availability component 620 as described with reference to FIG. 6.

At block 1120, the first device may transmit, by the first device, a packet on the channel immediately following a completion of the first CCA procedure as described above with reference to FIGS. 2-9. In certain examples, the operations of block 1020 may be performed by the packet transfer component 625 as described with reference to FIG. 6.

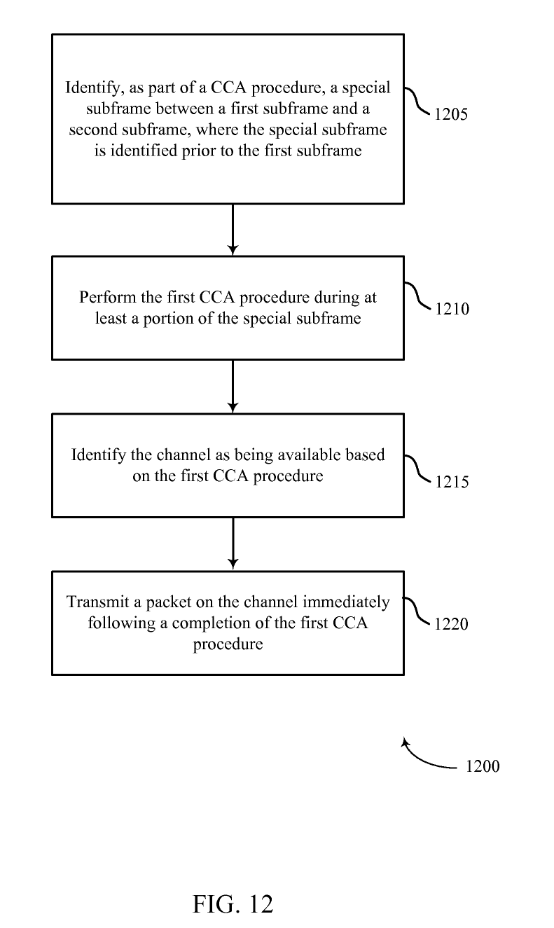

FIG. 12 shows a flowchart illustrating a method 1200 for CCA procedures in synchronized networks in accordance with various aspects of the present disclosure. In one embodiment, the operations of method 1200 may be implemented by a device such as UE 115 and/or base station 105 or its components as described with reference to FIGS. 1 and 2. For example, the operations of method 1200 may be performed by the CCA manager 510 as described herein. In some examples, the UE 115 and/or base station 105 may execute a set of codes to control the functional elements of the device to perform the functions described below. Additionally or alternatively, the UE 115 and/or base station 105 may perform aspects the functions described below using special-purpose hardware.

At block 1205, the first device may identify, as part of a CCA procedure, a special subframe between a first subframe and a second subframe, where the special subframe is identified prior to the first subframe as described above with reference to FIGS. 2-9. In certain examples, the operations of block 1205 may be performed by the CCA component 615 as described with reference to FIG. 6.

At block 1210, the first device may perform the first CCA procedure during at least a portion of the special subframe as described above with reference to FIGS. 2-9. In certain examples, the operations of block 1210 may be performed by the CCA component 615 as described with reference to FIG. 6.

At block 1215, the first device may identify the channel as being available based on the first CCA procedure as described above with reference to FIGS. 2-9. In certain examples, the operations of block 1215 may be performed by the channel availability component 620 as described with reference to FIG. 6.

At block 1220, the first device may transmit, by the first device, a packet on the channel immediately following a completion of the first CCA procedure as described above with reference to FIGS. 2-9. In certain examples, the operations of block 1220 may be performed by the packet transfer component 625 as described with reference to FIG. 6.

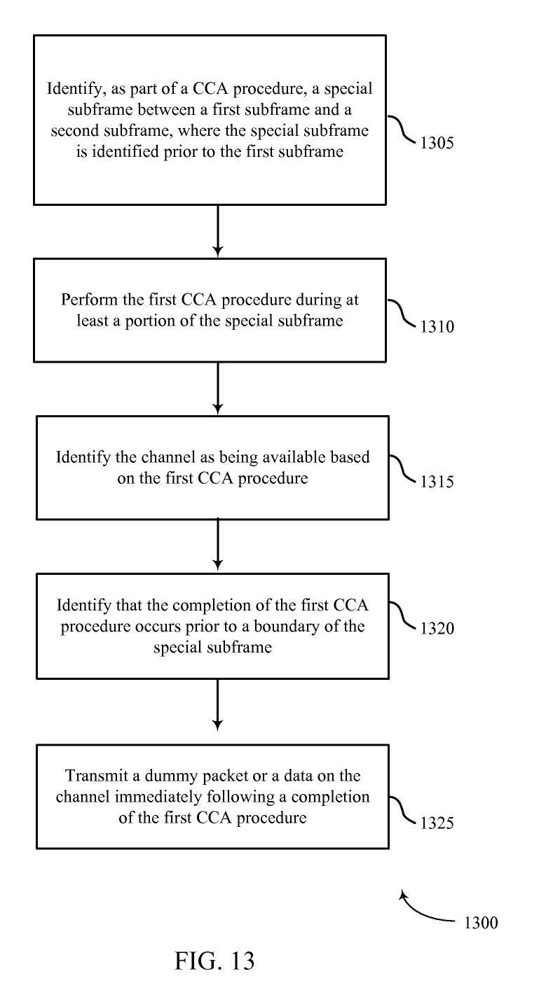

FIG. 13 shows a flowchart illustrating a method 1300 for CCA procedures in synchronized networks in accordance with various aspects of the present disclosure. In one embodiment, the operations of method 1300 may be implemented by a device such as UE 115 and/or base station 105 or its components as described with reference to FIGS. 1 and 2. For example, the operations of method 1300 may be performed by the CCA manager 510 as described herein. In some examples, the UE 115 and/or base station 105 may execute a set of codes to control the functional elements of the device to perform the functions described below. Additionally or alternatively, the UE 115 and/or base station 105 may perform aspects the functions described below using special-purpose hardware.

At block 1305, the first device may identify, as part of a CCA procedure, a special subframe between a first subframe and a second subframe, where the special subframe is identified prior to the first subframe as described above with reference to FIGS. 2-9. In certain examples, the operations of block 1305 may be performed by the special subframe component 705 as described with reference to FIG. 7.

At block 1310, the first device may perform the first CCA procedure during at least a portion of the special subframe as described above with reference to FIGS. 2-9. In certain examples, the operations of block 1310 may be performed by the CCA component 615 as described with reference to FIG. 6.

At block 1315, the first device may identify the channel as being available based on the first CCA procedure as described above with reference to FIGS. 2-9. In certain examples, the operations of block 1315 may be performed by the channel availability component 620 as described with reference to FIG. 6.

At block 1320, the first device may identify that the completion of the first CCA procedure occurs prior to a boundary of the subframe as described above with reference to FIGS. 2-9. In certain examples, the operations of block 1320 may be performed by the special subframe component 705 as described with reference to FIG. 7.

At block 1325, the first device may transmit a junk packet or a data on the channel immediately following a completion of the first CCA procedure as described above with reference to FIGS. 2-9. In certain examples, the operations of block 1325 may be performed by the packet transfer component 625 as described with reference to FIG. 6.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for clear channel assessment procedures in synchronized networks.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable channel. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical layer (PHY) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Computer-readable media includes both non-transitory computer storage media and communication media including any channel that facilitates transfer of a computer program from one place to another. A non-transitory storage channel may be any available channel that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory channel that can be used to carry or store desired program code means in the form of instructions or data structures and that can be accessed by a general-purpose or special-purpose computer, or a general-purpose or special-purpose processor. Also, any connection is properly termed a computer-readable channel. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of channel. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, frequency division multiple access (FDMA), orthogonal frequency-division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as global system for mobile communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, evolved NodeB (eNB), Home NodeB, a Home eNodeB (HeNB), or some other suitable terminology. The geographic coverage area for a base station may be divided into sectors making up only a portion of the coverage area. The wireless communications system or systems described herein may include base station of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including; for example, wireless communications system 100 of FIG. 1 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using frequency division duplex (FDD) (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for clear channel assessment procedures in synchronized networks. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
performing, by a first device in a synchronous network, a first clear channel assessment (CCA) procedure on a channel;
identifying the channel as being available based at least in part on the first CCA procedure; and
transmitting a packet on the channel immediately following a completion of the first CCA procedure.

2. The method of claim 1, wherein performing the first CCA procedure further comprises starting the first CCA procedure simultaneously with a second CCA procedure performed by a second device, the first CCA procedure and the second CCA procedure having a same count-down duration.

3. The method of claim 2, wherein the first device and the second device are associated with a first operator of the synchronous network.

4. The method of claim 1, wherein performing the first CCA procedure further comprises starting the first CCA procedure simultaneously with a second CCA procedure performed by a second device, the first CCA procedure having a first count-down duration and the second CCA procedure having a second count-down duration that is different from the first count-down duration.

5. The method of claim 4, wherein the first device is associated with a first operator of the synchronous network and the second device is associated with a second operator of the synchronous network, the second operator being different from the first operator.

6. The method of claim 1, wherein performing the first CCA procedure further comprises:
identifying a special subframe between a first subframe and a second subframe, wherein the special subframe is identified prior to the first subframe; and
performing the first CCA procedure during at least a portion of the special subframe.

7. The method of claim 6, wherein transmitting the packet on the channel immediately following the completion of the first CCA procedure further comprises:
identifying that the completion of the first CCA procedure occurs prior to a boundary of the special subframe; and
transmitting a junk packet or a data packet until the boundary of the special subframe.

8. The method of claim 6, wherein transmitting the packet on the channel immediately following the completion of the first CCA procedure further comprises:
identifying that the completion of the first CCA procedure occurs at a boundary of the special subframe; and
transmitting a data packet during each subframe following the special subframe.

9. The method of claim 6, wherein transmitting the packet on the channel immediately following the completion of the first CCA procedure further comprises:
identifying that the completion of the first CCA procedure occurs after a boundary of the special subframe; and
transmitting a junk packet or a data packet until the boundary of a subsequent subframe.

10. The method of claim 6, wherein the first subframe comprises an uplink (UL) subframe and the second subframe comprises a downlink (DL) subframe or the first subframe comprises a DL subframe and the second subframe comprises an UL subframe.

11. The method of claim 1, further comprising:
identifying data to be transmitted on the channel; and
performing the first CCA procedure based at least in part on the identifying.

12. The method of claim 1, wherein performing the first CCA procedure further comprises:
measuring energy on the channel; and
decoding one or more physical (PHY) layer convergence procedure (PLCP) headers associated with one or more wireless fidelity (Wi-Fi) transmissions during a special subframe.

13. The method of claim 1, further comprising:
transmitting the packet on the channel during each subsequent subframe until a special subframe occurs; and
performing a second CCA procedure during the special subframe.

14. The method of claim 1, wherein the first device comprises a base station or a user equipment (UE).

15. An apparatus for wireless communication comprising:
means for performing, by a first device in a synchronous network, a first clear channel assessment (CCA) procedure on a channel;
means for identifying the channel as being available based at least in part on the first CCA procedure; and
means for transmitting a packet on the channel immediately following a completion of the first CCA procedure.

16. The apparatus of claim 15, wherein performing the first CCA procedure further comprises:
means for starting the first CCA procedure simultaneously with a second CCA procedure performed by a second device, the first CCA procedure and the second CCA procedure having a same count-down duration.

17. The apparatus of claim 16, wherein the first device and the second device are associated with a first operator of the synchronous network.

18. The apparatus of claim 15, wherein performing the first CCA procedure further comprises means for starting the first CCA procedure simultaneously with a second CCA procedure performed by a second device, the first CCA procedure having a first count-down duration and the second CCA procedure having a second count-down duration that is different from the first count-down duration.

19. The apparatus of claim 18, wherein the first device is associated with a first operator of the synchronous network and the second device is associated with a second operator of the synchronous network, the second operator being different from the first operator.

20. The apparatus of claim 15, wherein performing the first CCA procedure further comprises:
means for identifying a special subframe between a first subframe and a second subframe, wherein the special subframe is identified prior to the first subframe; and
means for performing the first CCA procedure during at least a portion of the special subframe.

21. The apparatus of claim 20, wherein transmitting the packet on the channel immediately following the completion of the first CCA procedure further comprises:
means for identifying that the completion of the first CCA procedure occurs prior to a boundary of the special subframe; and
means for transmitting a junk packet or a data packet until the boundary of the special subframe.

22. The apparatus of claim 20, wherein transmitting the packet on the channel immediately following the completion of the first CCA procedure further comprises:
means for identifying that the completion of the first CCA procedure occurs at a boundary of the special subframe; and
means for transmitting a data packet during each subframe following the special subframe.

23. The apparatus of claim 20, wherein transmitting the packet on the channel immediately following the completion of the first CCA procedure further comprises:
means for identifying that the completion of the first CCA procedure occurs after a boundary of the special subframe; and
means for transmitting a junk packet or a data packet until the boundary of a subsequent subframe.

24. The apparatus of claim 20, wherein the first subframe comprises an uplink (UL) subframe and the second subframe comprises a downlink (DL) subframe or the first subframe comprises a DL subframe and the second subframe comprises an UL subframe.

25. The apparatus of claim 15, further comprising:
means for identifying data to be transmitted on the channel; and
means for performing the first CCA procedure based at least in part on the identifying.

26. The apparatus of claim 15, wherein performing the first CCA procedure further comprises:
means for measuring energy on the channel; and
means for decoding one or more physical (PHY) layer convergence procedure (PLCP) headers associated with one or more wireless fidelity (Wi-Fi) transmissions during a special subframe.

27. The apparatus of claim 15, further comprising:
means for transmitting the packet on the channel during each subsequent subframe until a special subframe occurs; and
means for performing a second CCA procedure during the special subframe.

28. The apparatus of claim 15, wherein the first device comprises a base station or a user equipment (UE).

29. An apparatus for wireless communication, comprising:
a processor;
memory in electronic communication with the processor; and
instructions stored in the memory and operable, when executed by the processor, to cause the apparatus to:
perform, by a first device in a synchronous network, a first clear channel assessment (CCA) procedure on a channel;
identify the channel as being available based at least in part on the first CCA procedure; and
transmit a packet on the channel immediately following a completion of the first CCA procedure.

30. A non-transitory computer-readable channel storing code for wireless communication, the code comprising instructions executable to:
perform, by a first device in a synchronous network, a first clear channel assessment (CCA) procedure on a channel;
identify the channel as being available based at least in part on the first CCA procedure; and
transmit a packet on the channel immediately following a completion of the first CCA procedure.
